(19) United States
(12) Patent Application Publication
(10) Pub. No.: US 2023/0369610 A1
(43) Pub. Date: Nov. 16, 2023

(54) LITHIUM PRIMARY BATTERY AND NON-AQUEOUS ELECTROLYTIC SOLUTION FOR LITHIUM PRIMARY BATTERY

(71) Applicant: Panasonic Intellectual Property Management Co., Ltd., Osaka-shi, Osaka (JP)

(72) Inventors: Kohei Saito, Osaka Fu (JP); Takayuki Nakatsutsumi, Osaka Fu (JP); Masanobu Takeuchi, Osaka Fu (JP)

(73) Assignee: Panasonic Intellectual Property Management Co., Ltd., Osaka-shi, Osaka (JP)

(21) Appl. No.: 18/246,781

(22) PCT Filed: Apr. 27, 2021
(86) PCT No.: PCT/JP2021/016751

§ 371 Date: Mar. 27, 2023

(30) Foreign Application Priority Data
Sep. 29, 2020 (JP) 2020-163724

(51) Int. Cl. H01M 6/14; H01M 4/505; H01M 4/06; H01M 4/66; H01M 4/134; H01M 4/70

(52) U.S. Cl. CPC H01M 6/14; H01M 4/505; H01M 4/06; H01M 4/66; H01M 4/134; H01M 4/70; H01M 2300/0017

(57) ABSTRACT

A lithium primary battery includes a positive electrode, a negative electrode, and a non-aqueous electrolyte. The positive electrode contains a positive electrode material mixture that contains LiₓMnO₂ (0≤x≤0.05). The negative electrode contains at least one of metal lithium and a lithium alloy. The non-aqueous electrolyte contains at least one of a cyclic imide component and a parole component as a first component and an oxalate phosphate complex component as a second component. The concentration of the first component in the non-aqueous electrolyte is 1 mass % or less. The concentration of the second component in the non-aqueous electrolyte is 6 mass % or less. The mass ratio of the first component relative to the second component in the non-aqueous electrolyte is 0.02 or more and 10 or less.

### TECHNICAL FIELD

The present disclosure relates to a non-aqueous electrolyte used in a lithium primary battery, and a lithium primary battery including the same.

### BACKGROUND ART

Lithium primary batteries are used as power sauces in many electronic devices because they have high energy density and low self-discharge. A lithium primary battery includes a negative electrode that contains metal lithium, a positive electrode, and a non-aqueous electrolyte. As an active material contained in the positive electrode, graphite fluoride, manganese dioxide, thionyl chloride, or the like is used.

Patent Literature 1 proposes the use of a non-aqueous electrolyte that contains an additive such as phthalimide from the viewpoint of suppressing an increase in the internal resistance of a primary or secondary battery during high temperature storage of the battery.

Patent Literature 2 proposes an additive composition for an electrolyte for a non-aqueous power storage device, wherein the additive compound contains, as an additive, a compound in which at least one of acidic protons contained in a specific acid is substituted with a silyl group that has three hydrocarbon groups. Patent Literature 2 teaches that the above-described additive suppresses the generation of gas in the lithium ion secondary battery when in use, and prevents the battery from expanding.

Patent Literature 3 proposes an electrolyte that contains LiB(C₂O₄)F₂ or the like as an electrolyte for an electrochemical device that has high heat resistance and high hydrolysis resistance.

Patent Literature 4 proposes the use of Li[P(C₂O₄)₃] that is more stable than LiPF₆ as a conductive salt in a lithium ion storage battery.

### CITATION LIST

### Patent Literature

[PTL 1] WO 2001/41247
[PTL 2] Japanese Laid-Open Patent Publication No. 2016-189327
[PTL 3] Japanese Laid-Open Patent Publication No. 2002-110235
[PTL 4] Japanese Patent No. 4695802

### SUMMARY OF INVENTION

Following improvements in the performance of electronic devices, lithium primary, batteries that are used as power wanes of electronic devices are required to have high discharge performance even after being stored at high temperatures. Even when a non-aqueous electrolyte that contains phthalimide is used in a lithium primary battery, an increase in the internal resistance of the battery dining high temperature storage is still insufficiently suppressed, and the discharge performance of the battery may decrease after being stared at a high temperature.

A first aspect of the present disclosure relates to a lithium primary battery including a positive electrode, a negative electrode, and a non-aqueous electrolyte, wherein the positive electrode contains a positive electrode material mixture that contains LiₓMnO₂ (0≤x≤0.05), the negative electrode contains at least one of metal lithium and a lithium alloy, the non-aqueous electrolyte contains at least one of a cyclic imide component and a pyrrole component as a first component and an oxalate phosphate complex component as a second component, the concentration of the first component in the non-aqueous electrolyte is 1 mass % or less, the concentration of the second component in the non-aqueous electrolyte is 6 mass % or less, and the mass ratio of the first component relative to the second component in the non-aqueous electrolyte is 0.02 or more and 10 or less.

A second aspect of the present disclosure relates to a lithium primary battery including a positive electrode, a negative electrode, and a non-aqueous electrolyte, wherein the positive electrode contains a positive electrode material mixture that contains LiₓMnO₂ (0≤x≤0.05), the negative electrode contains at least one of metal lithium and a lithium alloy, the non-aqueous electrolyte contains at least one of a cyclic imide component and a parole component as a first component and an oxalate phosphate complex component as a second component, the concentration of the first component in the non-aqueous electrolyte is 0.1 mass % cc more and 1 mass % or less, and the concentration of the second component in the non-aqueous electrolyte is 0.1 mass % cc more and 6 mass % or less.

A third aspect of the present disclosure relates to a non-aqueous electrolyte for a lithium primary battery that is used in a lithium primary battery that includes a positive electrode that contains a positive electrode material mixture that contains LiₓMnO₂ ((0≤x≤0.05), a negative electrode that contains at least one of metal lithium and a lithium alloy, and a non-aqueous electrolyte, wherein the non-aqueous electrolyte contains at least one of a cyclic imide component and a pyrrole component as a first component and an oxalate phosphate complex component as a second component, the concentration of the first component in the non-aqueous electrolyte is 0.1 mass % or more and 1 mass % or less, and the concentration of the second component ent in the non-aqueous electrolyte is 0.1 mass % or more and 6 mass % or less.

According to the present disclosure, it is possible to suppress an increase in the internal resistance of a lithium primary battery during high temperature storage.

### BRIEF DESCRIPTION OF DRAWINGS

FIG. 1 A front view, partially cut away, of a lithium primary battery according to one embodiment of the present disclosure.

### DESCRIPTION OF EMBODIMENTS

A lithium primary battery includes a positive electrode that contains LiₓMnO₂ (0≤x≤0.05), a negative electrode that contains at least one of metal lithium and a lithium alloy and a non-aqueous electrolyte. In the battery, in the case where the non-aqueous electrolyte contains a cyclic imide component, the increase in the internal resistance of the battery during high temperature storage is suppressed to a certain extent as compared with the case where the non-aqueous electrolyte does not contain a cyclic imide component, but the increase in the internal resistance of the battery dining high temperature storage is still insufficiently suppressed, and the discharge capacity of the battery may decrease after high temperature storage.

A lithium primary battery according to the present disclosure includes a positive electrode that contains a positive electrode material mixture that contains LiₓMnO₂ (0≤x≤0.05), a negative electrode that contains at least one of metal lithium and a lithium alloy, and a non-aqueous electrolyte. The non-aqueous electrolyte contains at least one of a cyclic imide component and a pyrrole component as a first component and an oxalate phosphate complex component as a second component. In the lithium primary battery configured as described above, the non-aqueous electrolyte satisfies at least one of the following conditions (a) and (b).
Condition (a): the concentration of the first component in the non-aqueous electrolyte is 1 mass % or less, the concentration of the second component in the non-aqueous electrolyte is 6 mass % or less, and the mass ratio (first component/second component) of the first component relative to the second component in the non-aqueous electrolyte is 0.02 or more and 10 or less.
Condition (b): the concentration of the first component in the non-aqueous electrolyte is 0.1 mass % or more and 1 mass % or less, and the concentration of the second component in the non-aqueous electrolyte is 0.1 mass % or more and 6 mass % or less.

According to the preset disclosure, the lithium primary battery contains the above-described non-aqueous electrolyte. Accordingly, irrespective of the fact that the non-aqueous electrolyte contains a cyclic imide component, the increase in the internal resistance of the lithium primary battery when stored in a high temperature environment is suppressed significantly, and the decrease in the discharge capacity of the lithium primary battery after high temperature storage is suppressed. The reason that such advantageous effects can be obtained in the present disclosure is considered to be as follows.

In the case where the non-aqueous electrolyte contains a cyclic imide component and no oxalate phosphate complex component, the increase in the internal resistance during storage is suppressed to a certain extent as compared with the case where the non-aqueous electrolyte contains neither a cyclic imide component nor an oxalate phosphate complex component, but the discharge capacity after high temperature storage decreases significantly. The reason for this is considered to be that the cyclic imide component oxidizes on the surface of the positive electrode to form a coating film that is derived from the cyclic imide component and has low lithium ion conductivity on the surface of the positive electrode, which inhibits the migration of lithium ions at the interface between the positive electrode and the electrolyte solution. Also, self-discharge of the positive electrode proceeds as the cyclic imide component oxidizes, and thus the discharge capacity after storage decreases. Particularly when the lithium primary battery is stored in a high temperature environment for a long period of time, the growth of the coating film on the positive electrode and self-discharge of the positive electrode are promoted, and thus the decrease in the discharge capacity of the battery after storage is prominent.

In the case where the non-aqueous electrolyte contains an oxalate phosphate complex component and no cyclic imide component, the increase in the internal resistance during storage is suppressed to a certain extent as compared with the case where the non-aqueous electrolyte contains neither an oxalate phosphate complex component nor a cyclic imide component, but the increase in the internal resistance diming storage is insufficiently suppressed. Also, a coating film that contains a component derived from the oxalate phosphate complex component has low thermal stability, and thus a side reaction proceeds during high temperature storage of the battery. As a result, the discharge capacity may decrease after high temperature storage. Also, a large amount of gas may be generated during storage.

In contrast, with the lithium primary battery of the present disclosure, the increase in the internal resistance of the battery dining high temperature a storage is suppressed significantly as compared with the case where the non-aqueous electrolyte contains neither a cyclic imide component nor an oxalate phosphate complex component. With the lithium primary battery of the present disclosure, the increase in the internal resistance of the battery daring high temperature storage is suppressed significantly as compared with an expected increase in the internal resistance of the battery in the case where the non-aqueous electrolyte contains either a cyclic imide component or an oxalate phosphate complex component. For this reason, it can be said that, when the non-aqueous electrolyte satisfies at least one of the conditions (a) and (b) described above, a synergistic effect imparted by the cyclic imide component and the oxalate phosphate complex component can be obtained in the suppression of an increase in the internal resistance of the battery dining high temperature storage. As described above, in the lithium primary battery of the present disclosure, the factors that significantly suppress the increase in the internal resistance of the battery daring high temperature storage are not necessarily clearly mown, but may be considered as follows. It is considered that, when the cyclic imide component decomposes on the positive electrode surface to form a coating film, the oxalate phosphate complex component is also involved in the decomposition reaction, and thus a coating film that contains a component that is denied from both the cyclic imide component and the oxalate phosphate complex component is formed. In the case where the coating film that contains a component derived from both the cyclic imide component and the oxalate phosphate complex component is formed, the resulting coating film is chemically and thermally stable, unlike the case where a coating film that contains a component that is derived from the cyclic imide component alone is formed. As a result of the coating film described above being funned, a side reaction caused by the positive electrode and the non-aqueous electrolyte coming into contact with each other during high temperature storage of the battery is unlikely to occur, an increase in internal resistance caused by the side reaction is suppressed significantly, and a decrease in discharge capacity caused by the increase in internal resistance is suppressed. Also, the generation of gas dining storage is also suppressed. Furthermore, the coating film that contains a component that is derived from both the cyclic imide component and the oxalate phosphate codex component has excellent lithium ion conductivity, and is therefore advantageous in reducing the internal resistance. This coating film is dense and has low electron conductivity, and thus after the coating film has been formed on the positive electrode surface at an early stage of the battery assembly, the oxidation of the cyclic imide component is unlikely to proceed, and the progress of the reduction of the positive electrode is mitigated. For this reason, self-discharge during storage of the lithium primary battery is reduced. Accordingly, it is considered that, by using an electrolyte solution that contains both a cyclic imide component and an oxalate phosphate complex component, the increase in the internal resistance of the battery during high temperature storage is suppressed significantly, and the decrease in the discharge capacity of the battery after storage is suppressed.

Even if the first component is a pyrrole component, it is possible to obtain the same advantageous effects as those obtained in the case where the first component is a cyclic imide component. In the case where the first component is a pyrrole component, it is considered that a coating film that contains a component that is derived from both the pyrrole component and the oxalate phosphate complex component is formed, the coating film is chemically and thermally stable and has excellent lithium ion conductivity, and thus the increase in the internal resistance of the battery during high temperature storage is suppressed significantly.

The present disclosure also encompasses a non-aqueous electrolyte used in a lithium primary battery that includes a positive electrode that contains a positive electrode material mixture that contains LiₓMnO₂ (0≤x≤0.05), a negative electrode that contains at least one of metal lithium and a lithium alloy, and a non-aqueous electrolyte. Here, the non-aqueous electrolyte contains a first component and a second component. The non-aqueous electrolyte satisfies the condition (b) described above. In addition, the present disclosure also encompasses the use of the non-aqueous electrolyte in a lithium primary battery that includes a positive electrode that contains a positive electrode material mixture that contains LiₓMnO₂ (0≤x≤0.05), a negative electrode that contain at least one of metal lithium and a lithium alloy, and the non-aqueous electrolyte.

Hereinafter, the lithium primary battery according to the present disclosure will be described in more detail.

[Lithium Primary Battery]

(Positive Electrode)

The positive electrode contains a positive electrode material mixture. The positive electrode material mixture contains a positive electrode active material. As the positive electrode active material contained in the positive electrode, manganese dioxide may be used. The positive electrode that contains manganese dioxide exhibits a relatively high voltage, and has excellent pulse discharge characteristics. Manganese dioxide may be in a mixed crystal state that includes a plurality of types of crystal states. The positive electrode may contain a manganese oxide other than manganese dioxide. Examples of the manganese oxide other than manganese dioxide include MnO, Mn₃O₄, Mn₂O₃, Mn₂O₇, and the like. It is preferable that manganese dioxide is the main manganese oxide of the manganese oxides contained in the positive electrode.

Some of the manganese dioxide contained in the positive electrode may be doped with lithium. When a small amount of lithium is doped, high capacity can be ensured. Manganese dioxide and manganese dioxide doped with a small amount of lithium can be represented by LiₓMnO₂ (0≤x≤0.05). It is sufficient that the average composition of the manganese oxides contained in the positive electrode is LiₓMnO₂ (0≤x≤0.05). The Li ratio represented by x may be 0.05 or less when the lithium primary battery is in the initial state of discharge. In general, the Li ratio represented by x increases as the discharge of the lithium primary battery proceeds. The oxidation number of manganese contained in manganese dioxide is theoretically 4 (tetravalent). However, the oxidation number of manganese may vary slightly front 4 (tetravalent) when a manganese oxide other than manganese dioxide is contained in the positive electrode, or manganese dioxide is doped with lithium. For this reason, in LiₓMnO₂, a small margin of error in the average oxidation number of manganese from 4 (tetravalent) is allowed.

The positive electrode may contain, in addition to LiₓMnO₂, a positive electrode active material that is used in lithium primary batteries as an additional positive electrode active material. As the additional positive electrode active material, graphite fluoride or the like can be used. From the viewpoint of easily exhibiting the advantageous effects obtained using the non-aqueous electrolyte that satisfies the condition (a) or (b) described above, the proportion of LiₓMnO₂ to the entire amount of positive electrode active materials is preferably 90 mass % or more.

As manganese dioxide, an electrolytic manganese dioxide is preferably used. It is also possible to use an electrolytic manganese dioxide that has undergone at least one of a neutralization process, a cleaning process, and a firing process as needed.

In general, an electrolytic manganese dioxide is obtained through electrolysis of an aqueous solution of manganese sulfate. For this reason, the electrolytic manganese dioxide inevitably contains sulfate ions. A positive electrode material mixture produced using an electrolytic manganese dioxide as described above inevitably contains sulfur atoms. The amount of sulfur atoms contained in the positive electrode material mixture may be 0.05 parts by mass or more and 3 parts by mass or less relative to 100 parts by mass of manganese atoms contained in the positive electrode material mixture. When the amount of sulfur atoms is within this range, it is considered that, in the lithium primary battery, the sulfate ions and unstable Mn³⁺ generated by the insertion of lithium into LiₓMnO₂ interact with each other, and the generation of Mn²⁺ caused by disproportionation of Mn³⁺ is suppressed. It is therefore considered that the elution of Mn²⁺ into the non-aqueous electrolyte and the deposition of Mn on the negative electrode are suppressed. As a result, it is possible to obtain a highly reliable lithium primary battery while ensuring high capacity. On the other hand, in the lithium secondary battery, some of the sulfate ions decompose during charging. Accordingly, even if the positive electrode material mixture contains a sulfate in such an amount that achieves an amount of sulfur atoms within the above-described range, it is difficult to sufficiently ensure the above-described advantageous effects. The proportion of sulfur atoms contained in the positive electrode material mixture can be adjusted by adjusting the conditions of the cleaning process and the neutralization process. As the cleaning process, for example, at least one of a water-washing process and an acid-washing process may be performed. As a neutralizing agent used in the neutralization process, for example, an inorganic base such as ammonium or a hydroxide is used.

By adjusting electrosynthesis conditions, the degree of crystallization of manganese dioxide can be increased, and the specific surface area of the electrolytic manganese dioxide can be reduced. The BET specific surface area of LiₓMnO₂ may be 10 m²/g or more and 40 m²/g or less. When the BET specific surface area of LiₓMnO₂ is within this range, in the lithium primary battery, an increased effect of suppressing self-discharge can be obtained. Also, a positive electrode material mixture layer can be easily formed.

The BET specific surface area of LiₓMnO₂ can be measured using a known method. The BET specific surface area is measured based on a BET method using, for example, a specific surface area measurement apparatus (for example, available from Mountech Co., Ltd.). For example, as a measurement sample. LiₓMnO₂ that has been separated from the positive electrode that has been removed from the battery may be used.

The median particle size of LiₓMnO₂ may be 10 μm or more and 40 μm or less. When the median particle size is within this range, in the lithium primary battery, the effect of suppressing self-discharge can be further increased, and high current collecting performance can be easily ensured in the positive electrode.

The median particle size of LiₓMnO₂ is, for example, the median value in a particle size distribution obtained using a quantitative laser diffraction/scattering method (qLD method). For example, as a measurement sample, LiₓMnO₂ that has been separated from the positive electrode that has been removed from the battery may be used. The median particle size is measured using, for example, SALD-7500 nano available from Shimadzu Corporation.

The positive electrode material mixture may contain a binder in addition to the positive electrode active material. The positive electrode material mixture may contain a conductive agent.

As the binder, for example, fluorine resin, rubber particles, or acrylic resin may be used.

As the conductive agent, for example, a conductive carbon material may be used. Examples of the conductive carbon material include natural graphite, artificial graphite, carbon black, and carbon fibers.

The positive electrode may further include a positive electrode current collector for retaining the positive electrode material mixture. The positive electrode current collector may be made of a material such as, for example, stainless steel, aluminum, or titanium.

In the case where the lithium primary battery is a coin-type battery, the positive electrode may be configured by attaching a ring-shaped positive electrode current collector that has an L-shaped cross section to a positive electrode material mixture pellet, or the positive electrode may be configured using only a positive electrode material mixture pellet. The positive electrode material mixture pellet can be obtained by, for example, subjecting a wet positive electrode material mixture prepared by adding an appropriate amount of water to a positive electrode active material and an additive to compression molding, and drying the positive electrode material mixture.

In the case where the lithium primary battery is a cylindrical battery, a positive electrode that includes a sheet-shaped positive electrode current collector and a positive electrode material mixture layer that is held by the positive electrode current collector can be used. As the sheet-shaped positive electrode current collector, it is preferable to use a porous current collector. As the porous current collector, an expanded metal, a net, a piece of punched metal, or the bike can be used. The positive electrode material mixture layer can be obtained by for example, applying a wet positive electrode material mixture described above to the surface of a sheet-shaped positive electrode current collector or filling the positive electrode current collector with the positive electrode material mixture, pressing the positive electrode current collector in the thickness direction, and drying the positive electrode current collector.

It is preferable that the positive electrode includes a porous current collector as described above and a positive electrode material mixture filling the current collector. Specifically, it is preferable to use a current collector that contains at least one material selected from the gimp consisting of SUS 444, SUS 430, and SUS 316. By using the current collector described above, in the lithium primary battery, it is possible to suppress a side reaction between the current collector and the non-aqueous electrolyte and corrosion of the current collector, and thus an increase in internal resistance and the generation of gas can be suppressed. Particularly when the current collector described above is used in combination with a non-aqueous electrolyte that contains at least one of LiCF₃SO₃ and LiClO₄ (which will be described later) that are typically used as lithium salts in lithium primary batteries, the side reaction between the current collector and the non-aqueous electrolyte can be more effectively suppressed. The thickness of the positive electrode is, for example, 300 μm or mode and 900 μm or less. When a positive electrode with a thickness within this range is used, the dispersibility of the non-aqueous electrolyte in the positive electrode material mixture tends to be reduced, and the reduction of the positive electrode caused by oxidation of the solvent or the cyclic imide component (first component) is suppressed, and thus self-discharge can be suppressed. Normally, a lithium primary battery is discharged at a low rate for a long period of time, and thus an increase in the resistance of the battery when the thickness of the positive electrode is within this range is allowed.

(Negative Electrode)

The negative electrode may contain either metal lithium or a lithium alloy, or both. For example, a composite that contains metal lithium and a lithium alloy may be used as the negative electrode.

As the lithium alloy an Li—Al alloy, an Li—Sn alloy, an Li—Ni—Si alloy, an Li—Pb alloy, or the like can be used. The amount of metal elements other than lithium contained in the lithium alloy is preferably 0.05 to 15 mass % from the viewpoint of acting the discharge capacity and stabilizing the internal resistance.

The metal lithium, the lithium alloy, or the composite thereof is molded into a suitable shape with an appropriate thickness according to the shape, the size, the standard performance, and the like of the lithium primary battery.

In the case where the lithium primary battery is a coin-type battery, a disc-shaped piece obtained by punching hoop-shaped metal lithium, lithium alloy, or a composite thereof into a disc may be used as the negative electrode. In the case where the lithium primary battery is a cylindrical battery, a sheet made of metal lithium, a lithium alloy or a composite thereof may be used as the negative electrode. The sheet is obtained through, for example, extrusion molding. More specifically, in the cylindrical battery, a metal lithium foil, a lithium alloy foil, or the him that has a shape that has a lengthwise direction and a widthwise direction is used.

In the case where the lithium primary battery is a cylindrical battery a long piece of tape that includes a resin substrate and an adhesive laver may be attached to at least one main surface of the negative electrode along the lengthwise direction. The term “main surface” means a surface that faces the positive electrode. The width of the tape may be, for example, 0.5 mm or more and 3 mm or less. The tape functions to, when the lithium component of the negative electrode is consumed by the reaction at the end of discharging, prevent the foil of the negative electrode from bra and causing a current-collection failure. The occurrence of a current-collection failure results in a reduced battery capacity. However, the adhesive strength of the tape is reduced by the electrolyte solution during long-term storage. When the electrolyte solution that contains a first component and a second component is used, the reduction of the adhesive strength can be suppressed, and it is possible to more effectively prevent the occurrence of a current-collection failure caused by breakage of the foil of the negative electrode.

As the material of the resin substrate, for example, a polyolefin such as fluorine resin, polyimide, polyphenylene sulfide, polyether sulfone, polyethylene, or polypropylene, polyethylene terephthalate, or the like can be used. Specifically, it is preferable to use polyolefin, and it is more preferable to use polypropylene.

The adhesive layer contains, for example, at least one component selected from the group consisting of a rubber component, a silicone component, and an acrylic resin component. Specifically, as the rubber component, a synthetic rubber, a natural rubber, or the like may be used. Examples of the synthetic rubber include butyl rubber, butadiene rubber, styrene-butadiene rubber, isoprene rubber, neoprene, polyisobutylene, acrylonitrile-butadiene rubber, a styrene-isoprene block copolymer, a styrene-butadiene block copolymer, a styrene-ethylene-butadiene block copolymer, and the like. As the silicone component, an organic compound that has a polysiloxane structure, a silicone-based polymer, or the like may be used. Examples of the silicone-based polymer include a peroxide-curable silicone, an addition-reaction silicone, and the like. As the acrylic resin component, a polymer that contains an acrylic monomer such as acrylic acid, methacrylic acid, acrylic acid ester, or methacrylic acid ester can be used. Other examples include: polymers or copolymers of acrylic monomers such as acrylic acid, methacrylic acid, methyl acrylate, methyl methacrylate, ethyl acrylate, ethyl methacrylate, propyl acrylate, propyl methacrylate, butyl acrylate, butyl methacrylate, octyl acrylate, octyl methacrylate, 2-ethylhexyl acrylate, and 2-ethylhexyl methacrylate; and the him. The adhesive layer may also contain a cross-linking agent, a plasticizing agent, and a tackifier.

(Non-Aqueous Electrolyte)

The non-aqueous electrolyte contains, for example, a fast component (at least one of a cyclic imide component and a pyrrole component), a second component (an oxalate phosphate complex component), and a non-aqueous solvent far dissolving the first component and the second component. The non-aqueous electrolyte contains a lithium salt or lithium ions. At least one of the first component and the second component may be a lithium salt, or may be capable of generating lithium ions. Also, the non-aqueous electrolyte may contain a lithium salt other than the first component and the second component.

(Oxalate Phosphate Complex Component)

The oxalate phosphate complex component may have a structure that can produce at least anions represented by a formula (1) given below. In the formula (1), * indicates a bond. The non-aqueous electrolyte may contain one type of oxalate phosphate complex component or two types or more of oxalate phosphate complex components.

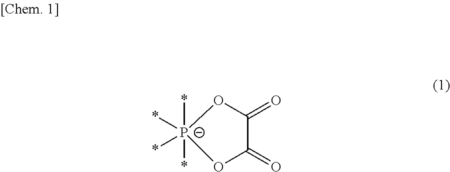 [SMILES: *[P-]1(*)(*)(*)OC(=O)C(=O)O1]

The oxalate phosphate complex component may be contained in the form of an acid (or anions) or a salt in the non-aqueous electrolyte. It is sufficient that the oxalate phosphate complex component can produce at least oxalate phosphate complex anions in the non-aqueous electrolyte. The oxalate phosphate complex component may be a salt of oxalate phosphate complex anions and cations contained in the non-aqueous electrolyte.

In the oxalate phosphate complex component, it is sufficient that at least one oxalate ligand is coordinated to one phosphorus atom, and two oxalate ligands or three oxalate ligands may be coordinated to one phosphorus atom.

The oxalate phosphate complex component may haw a structure in which one oxalate ligand and four halogen atoms are coordinated to one phosphorus atom. The oxalate phosphate complex component that has the above-described structure can produce anions represented by a formula (2) given below.

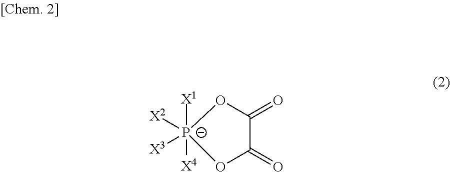

In the formula (2), X¹ to X⁴ each represent a halogen atom Examples of the halogen atoms coordinated to a phosphors atom include fluorine atoms and chlorine atoms.

Alternatively, the oxalate phosphate complex component may have a structure in which two oxalate ligands and two halogen atoms are coordinated to one phosphorus atom. The oxalate phosphate complex component that has the above-described structure can produce anions represented by a formula (3) given below

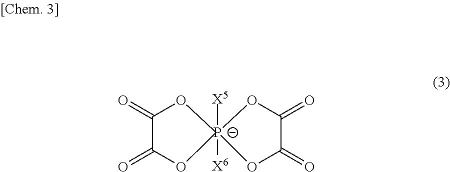

In the formula (3), X⁵ and X⁶ each represent a halogen atom Examples of the halogen atoms coordinated to a phosphorus atom include fluorine atoms and chlorine atoms.

As the oxalate phosphate complex component, a tetrafluoro(oxalate)phosphate complex component, a difluoro bis(oxalate)phosphate complex component, and a tris(oxalate)phosphate complex component are preferably used. Specifically, as the oxalate phosphate complex component, it is preferable to use lithium tetrafluoro(oxalate)phosphate, lithium difluoro bis(oxalate)phosphate, and lithium tris(oxalate)phosphate.

The tetrafluoro(oxalate)phosphate complex component has a structure in which one oxalate ligand and four fluorine atoms are coordinated to one phosphorus atom. The difluoro bis(oxalate)borate complex component has a stricture in which two oxalate ligands and two fluorine atone are coordinated to one phosphorus atom. The tris(oxalate)phosphate complex component has a stricture in which three oxalate ligands are coordinated to one phosphorus atom, and can produce anions represented by a formula (4) given below.

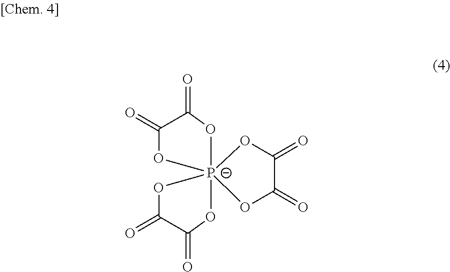 [SMILES: O=C1O[P-]23(OC1=O)(OC(=O)C(=O)O2)OC(=O)C(=O)O3]

In the case where the non-aqueous electrolyte satisfies the condition (a) described above, the concentration of the oxalate phosphate complex component in the non-aqueous electrolyte may be 6 mass % or less, 5.5 mass % or less, or 5 mass % or less. When the couch of the oxalate phosphate complex component is greater than 6 mass %, a side reaction proceeds during high temperature storage of the battery, and the discharge capacity after storage decreases. The concentration of the oxalate phosphate complex component in the non-aqueous electrolyte may be any value as long as it is greater than or equal to a detection limit, and may be 0.1 mass % or more or 0.5 mass % or more. The upper limit values and the lower limit values can be combined in any manner.

During storage or discharging of the lithium primary battery, the oxalate phosphate complex component is consumed in processes such as forming a coating film in the lithium primary battery, and the concentration of the oxalate phosphate complex component in the non-aqueous electrolyte varies. The concentration of the oxalate phosphate complex component in the non-aqueous electrolyte used to assemble or produce the battery is preferably 0.1 mass % or more, and more preferably 0.5 mass % or more. In this case, the increase in the internal resistance of the battery during high temperature storage is remarkably suppressed. The concentration of the oxalate phosphate complex component in the non-aqueous electrolyte used to assemble or produce the battery is preferably 5.5 mass % or less, and more preferably 5 mass % or less. In this case, the decrease in the capacity of the battery after high temperature storage is likely to be suppressed. The upper limit values and the lower limit values can be combined in any manner.

In the case where the non-aqueous electrolyte satisfies the condition (b) described above, the concentration of the oxalate phosphate complex component in the non-aqueous electrolyte may be 0.1 mass % or more and 6 mass % or less, 0.1 mass % or more and 5.5 mass % or less, 0.5 mass % or more and 5.5 mass % or less, or 1 mass % or more and 5 mass % or less. When the concentration of the oxalate phosphate complex component is within this range, the increase in the internal resistance of the battery during high temperature storage is likely to be suppressed, and the decrease in the capacity of the battery after high temperature storage is remarkably suppressed.

As described above, the oxalate phosphate complex component may be contained in the fain of an acid (or anions) in the non-aqueous electrolyte. In the specification of the present application, the concentration or the amount by mass of the oxalate phosphate complex component in the non-aqueous electrolyte refers to a value obtained through conversion as the concentration or the amount by mass of the lithium salt in the oxalate phosphate complex.

(Cyclic Imide Component)

The cyclic imide component may be, for example, a cyclic diacylamine. The cyclic imide component may have a diacylamine ring (also referred to as an imide ring). Another ring (also referred to as a second ring) may be condensed with the imide ring. The non-aqueous electrolyte may contain only one type of cyclic imide component, or two or more types of cyclic imide components. The cyclic imide component may be contained in the form of an imide in the non-aqueous electrolyte, or may be contained in the form of anions or a salt. In the case where the cyclic imide component is contained in the form of an imide in the non-aqueous electrolyte, the cyclic imide component may be contained in the form of a free NH group or a tertiary amine.

The second ring may be an aromatic ring, a saturated or unsaturated aliphatic ring, or the like. The second ring may have at least one hetero atom. The hetero atom may be an oxygen atom, a sulfur atom, a nitrogen atom, or the like.

Examples of the cyclic imide that constitutes the cyclic imide component include an aliphatic dicarboxylic acid imide and a cyclic imide that has a second ring. The aliphatic dicarboxylic acid imide may be, far example, succinimide or the like. The cyclic imide that has a second ring may be an imide of an aromatic or aliphatic dicarboxylic acid, or the like. The aromatic dicarboxylic acid or the aliphatic dicarboxylic acid may be, for example, a dicarboxylic acid that has a carboxy group attached to each of two adjacent atoms that constitute the ring. The cyclic imide that has a second ring may be, for example, phthalimide or hydrogenated phthalimide. The hydrogenated phthalimide may be cyclohexa-3-en-1,2-dicarboximide, cyclohexane-1,2-dicarboximide, or the like.

The imide ring may be an N-substituted imide ring that has a substituent on the nitrogen atom of the imide. Examples of the substituent include a hydroxy group, an alkyl group, an alkoxy group, a halogen akin, and the like. The alkyl group is, for example, a C₁₋₄ alkyl group, and may be a methyl group, an ethyl group, or the like. The alkoxy group is, for example, a C₁₋₄ alkoxy group, and may be a methoxy group, an ethoxy group, or the like. The halogen atom may be a chlorine atom, a fluorine atom, or the like.

Among the cyclic imide components, it is more preferable to use phthalimide, an N substituted phthalimide, or the like. As the substituent on the nitrogen atom of the N-substituted phthalimide, any substituent can be selected from those listed above as examples of the substituent of the N-substituted imide ring. It is more preferable to use a cyclic imide component that contains at least phthalimide.

(Pyrrole Component)

The pyrrole component contains nipple and a derivative thereof and may have a pyrrole ring. The non-aqueous electrolyte may contain only one type of pp role component, or two or mote types of pyrrole components. The pyrrole component may be contained in the form of a pyrrole or in the form of anions or a salt in the non-aqueous electrolyte. In the case where the pyrrole component is contained in the firm of a pyrrole in the non-aqueous electrolyte, it may be contained in the form of a free NH group or a tertiary amine.

The pyrrole ring may be an N-substituted pyrrole ring that has a substituent on the nitrogen atom of the pyrrole. As the substituent, any substituent can be selected from those listed above as examples of the substituent of the N-substituted imide ring.

Another ring (also referred to as a second ring) may be condensed with the pyrrole ring. The second ring may be an aromatic ring, a saturated or unsaturated aliphatic ring, or the like. The second ring may have at least one hetero atom. The hetero atom may be an oxygen atom, a sulfur atom, a nitrogen atom, or the like. Examples of the pyrrole component that has a second ring include indole, an N-substituted indole, isoindole, an N-substituted isoindole, porphyrin, an N substituted porphyrin, and the like. As the substituent on the nitrogen atom of the N-substituted indole or the like, any substituent can be selected from those listed above as examples of the substituent of the N-substituted imide ring.

In the case where the non-aqueous electrolyte satisfies the condition (a) described above, the mass ratio of the first component relative to the second component in the non-aqueous electrolyte is 0.02 or more and 10 or less, and may be 0.02 or more and 7 or less, 0.02 or more and 5 or less, or 0.1 or more and 5 or less. When the mass ratio is within this range, a high quality coating film that has excellent lithium ion conductivity, chemical stability, and thermal stability is more likely to be formed on the positive electrode surface. Accordingly, the increase in the internal resistance of the battery during high temperature storage is remarkably suppressed.

The concentration of the first component in the non-aqueous electrolyte is 1 mass % or less, or may be 0.7 mass % or less, or 0.5 mass % or less. When the concentration of the first component is within this range, the increase in the internal resistance of the battery during high temperature storage and the decrease in the capacity of the battery after storage are further suppressed. The concentration of the first component in the non-aqueous electrolyte may be any value as long as it is greater than or equal to a detection limit, and may be 0.1 mass % or more, or 0.3 mass % or more. The upper limit values and the lower limit values can be combined in any manner.

When the concentration of the first component in the non-aqueous electrolyte is greater than 1 mass %, a coating film with low lithium ion conductivity forms on the positive electrode surface during high temperature storage of the battery, and the discharge capacity after high temperature storage decreases.

Doing storage or discharging of the battery, the fast component is consumed in processes such as forming a coating film in the battery, and the concentration of the first component in the non-aqueous electrolyte varies. The concentration of the first component in the non-aqueous electrolyte used to assemble or produce the battery is preferably 0.1 mass % or more, or 0.3 mass % or more. In this case, the increase in the internal resistance of the battery during high temperature storage is likely to be effectively suppressed. Also, the concentration of the first component in the non-aqueous electrolyte used to assemble or produce the battery is preferably 1 mass % or less, or 0.7 mass % or less. In this case, the decrease in the capacity of the battery after high temperature storage is remarkably suppressed.

In the case where the non-aqueous electrolyte satisfies the condition (b) described above, it is sufficient that the concentration of the first component in the non-aqueous electrolyte is 0.1 mass % or more and 1 mass % or less, and may be 0.3 mass % or more and 1 mass % or less, or 0.3 mass % or more and 0.7 mass % or less. When the concentration of the first component is within this range, the increase in the internal resistance of the battery during high temperature storage is likely to be suppressed significantly, and the decrease in the capacity of the battery after storage is remarkably suppressed.

Also, the mass ratio of the first component relative to the second component in the non-aqueous electrolyte may be 0.02 or more and 10 or less, 0.02 or more and 7 or less, 0.02 or more and 5 or less, or 0.1 or more and 5 or less. When the mass ratio is within this range, the increase in the internal resistance of the battery curing high temperature storage is likely to be effectively suppressed, and the decrease in the capacity of the battery after storage is further suppressed.

The first component may be contained in the form of a salt in the non-aqueous electrolyte. In the specification of the present application, the concentration or the amount by mass of the first component in the non-aqueous electrolyte refers to a value obtained through conversion as the concentration or the amount by mass of the first component that has a free NH group.

The non-aqueous electrolyte (the first component and the second component) can be analyzed using, for example, liquid chromatography-mass spectrometry (LC/MS), and ultraviolet spectrometry (UV) may be performed together with mass spectrometry (MS).

(Non-Aqueous Solvent)

As the non-aqueous solvent, an organic solvent that is ordinarily used in a non-aqueous electrolyte of a lithium primary battery can be used. Examples of the non-aqueous solvent include an ether, an ester, a carbonic ester, and the like. As the non-aqueous solvent, dimethyl ether, γ-butyl lactone, propylene carbonate, ethylene carbonate, 1,2-dimethoxyethane, and the like can be used. The non-aqueous electrolyte may contain only one type of non-aqueous solvent, or two types or more of non-aqueous solvents.

From the viewpoint of improving the discharge characteristics of the lithium primary battery, the non-aqueous solvent preferably contains a cyclic carbonic ester that has a high boiling point and a linear ether that has low viscosity even in a low temperature environment. The cyclic carbonic ester preferably contains at least one selected from propylene carbonate (PC) and ethylene carbonate (EC), and it is particularly preferable that the cyclic carbonic ester contains PC. The linear ether preferably has a viscosity of 1 mPa·s or less at 25° C., and it is particularly preferable that the linear ether contains dimethoxyethan a (DME). The viscosity of the non-aqueous solvent is determined though measurement performed at a temperature of 25° C. and a shear rate of 10000 (1/s) using a small sample viscometer m-VROC available from Rheosense, Inc.

(Lithium Salt)

The non-aqueous electrolyte may contain a lithium salt other than the oxalate phosphate complex component and the cyclic imide component. As the lithium salt, for example, a lithium salt that is used as a solute in a lithium primary battery can be used Examples of the lithium salt include LiCF₃SO₃, LClO₄, LrBF₄, LrPF₆, LiRaSO₃ (where Ra represents a fluorinated alkyl group having 1 to 4 carbon atoms), LiFSO₃, LiN(SO₂R_{b})(SO₂Rc) (where Rb and Rc each independently represent a fluorinated alkyl group having 1 to 4 carbon atoms), LN(FSO₂)₂, LiPO₂F₂, LiB(C₂O₄)₂, and LiBF₂(C₂O₄). These lithium salts may be contained alone or hi a combination of two or more in the non-aqueous electrolyte.

(Others)

The concentration of lithium ions contained in the non-aqueous electrolyte (the total concentration of lithium salts) is, for example, 0.2 to 2.0 mol/L, and may be 0.3 to 1.5 mol/L.

The non-aqueous electrolyte may optionally contain additives. Examples of the additives include propane sultan, vinylene carbonate, and the like. The total ration of the additives contained in the non-aqueous electrolyte is, far example, 0.003 to 5 mol/L.

(Separator)

The lithium primary battery normally includes a separator between the positive electrode and the negative electrode. As the separator, a porous sheet made using an imitating material that is resistant to the internal environment of the lithium primary battery may be used. Specific examples of the porous sheet include a nonwoven fabric made of a synthetic resin, a microporous film made of a synthetic resin, a stacked body thereof, and the like.

Examples of the synthetic resin used in the nonwoven fabric include polypropylene, polyphenylene sulfide, polybutylene terephthalate, and the like. Examples of the synthetic resin used in the microporous film include: polyolefin resins such as polyethylene, polypropylene, and an ethylene-propylene copolymer, and the like. The microporous film may contain inorganic particles as needed.

The thickness of the separator is, for example, 5 μm or more and 100 μm or less.

The structure of the lithium primary battery is not particularly limited. The lithium primary battery may be a coin-type battery that includes a stacked electrode group formed by slacking a circular positive electrode and a circular negative electrode with a separator interposed therebetween. Alternatively, the lithium primary battery may be a cylindrical battery that includes a wound electrode group formed by spirally winding a strip-like positive electrode and a strip-like negative electrode with a separator interposed therebetween.

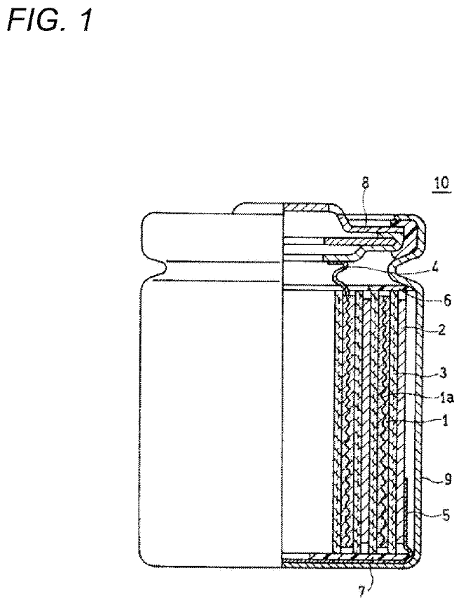

FIG. 1 shows a front view, partially cut away, of a cylindrical lithium primary battery according to one embodiment of the present disclosure. A lithium primary battery 10 is formed by housing an electrode group formed by spirally winding a positive electrode 1 and a negative electrode 2 with a separator 3 interposed therebetween in a battery case 9 together with a non-aqueous electrolyte. A sealing plate 8 is attached to the opening of the battery case 9. A positive electrode lead 4 that is connected to a current collector 1a of the positive electrode 1 is connected to the sealing plate 8. A negative electrode lead 5 that is connected to the negative electrode 2 is connected to the case 9. Also, an upper insulating plate 6 and a lower insulating plate 7 are provided on top and bottom of the electrode group, respectively, to prevent an internal short circuit.

### EXAMPLES

Hereinafter, the present disclosure will be described in detail based on examples and comparative examples. However, the present disclosure is not limited to the examples given below.

### Examples 1 to 10 and Comparative Examples 4 to 6

(Production of Positive Electrode)

A wet positive electrode material mixture was prepared by adding 5 parts by mass of ketjen black as a conductive agent, 5 parts by mass of polytetrafluoroethylene as a binder, and an appropriate amount of pure water to 100 parts by mass of electrolytic manganese dioxide, and mixing and kneading them, so as to produce a positive electrode.

Next, a positive electrode precursor was produced by Filing a positive electrode current collector made of a 0.1 mm-thick expanded metal made of stainless steel (SUS 444) with the positive electrode material mixture. Then, the positive electrode precursor was dried and rolled to a thickness of 0.4 mm using a roll press, and cut into a sheet with a length of 2.2 cm and a width of 1.5 cm. In this way, a positive electrode was obtained. Next, a portion of the positive electrode material mixture filling the positive electrode current collector was removed, and a tab lead made of SUS 444 was connected to the exposed portion of the positive electrode current collector through resistance welding.

(Production of Negative Electrode)

A negative electrode was obtained by cutting a 300 μm-thick metal lithium foil into a shape with a length of 4 cm and a width of 2.5 cm. A tab lead made of nickel was connected to a predetermined portion of the negative electrode through pressure welding.

(Production of Electrode Group)

An electrode group was produced by stacking the positive electrode, around which a separator was wound, on the negative electrode to face the negative electrode. As the separator, a 25 μm-thick microporous film made of polypropylene was used.

(Preparation of Non-Aqueous Electrolyte)

PC, EC, and DME were mixed at a volume ratio of 4:2:4. LiCF₃SO₃ was dissolved in the resulting mixture at a concentration of 0.5 mol/L, and the first component and the second component shown in Tables 1 and 2 were dissolved at the concentrations shown in Tables 1 and 2. In this way, a non-aqueous electrolyte was prepared. Regarding the second components shown in Tables 1 and 2, LiDFOP stands for lithium difluoro bis(oxalate)phosphate, LiTFOP stands for lithium tetrafluoro(oxalate)phosphate, and LiTOP stands for lithium tris(oxalate)phosphate.

(Assembly of Lithium Primary Battery)

The electrode group was housed in a cylindrical aluminum laminate package with a length of 9 cm and a width of 6 cm such that a portion of each of the tab leads connected to the positive electrode and the negative electrode, respectively, was exposed from the package, and an opening of the package on the tab lead side was sealed. The electrolyte solution in an amount of 0.5 mL was injected from an opening of the package opposite to the tab lead side, and the opening was sealed through vacuum heat sealing. In this way, a test lithium primary battery was produced. The design capacity of the lithium primary battery was 308 mAh/g (the capacity per unit mass of the positive electrode active material). In Tables 1 and 2, A1 to A10 indicate the batteries produced in Examples 1 to 10, and B1 to B6 indicate the batteries produced in Comparative Examples 1 to 6.

In the lithium primary batteries produced in Examples, the amount of sulfate-derived sulfur atoms contained in the positive electrode material mixture was 0.05 parts by mass or more and 1.25 parts by mass or less relative to 100 parts by mass of manganese atoms contained in the positive electrode material mixture. In the lithium primary batteries produced in Examples, the median particle size of LiₓMnO₂ contained in the positive electrode was 25 μm to 27 μm, and the BET specific surface area of the same was 15 to 20 m²/g.

### Comparative Example 1

A battery B1 of Comparative Example 1 was produced in the same manner as the battery A1 of Example 1, except that the first component was not contained in the non-aqueous electrolyte.

### Comparative Example 2

A battery B2 of Comparative Example 2 was produced in the same manner as the battery A1 of Example 1, except that the second component was not contained in the non-aqueous electrolyte.

### Comparative Example 3

A battery B3 of Comparative Example 3 was produced in the same manner as the battery A1 of Example 1, except that the first component and the second component were not contained in the non-aqueous electrolyte.

For each of the batteries A1 to A4 and the batteries B1 to B3, the rate of increase in internal resistance after high temperature storage was measured in the manner described below.

[Evaluation 1: Rate of Increase in Internal Resistance after High Temperature Storage]

Each battery was discharged immediately after assembly in an amount corresponding to 2.5% of the design capacity, and stored at 60° C. for 3 days. Then, internal resistance R0 of the battery after storage was measured. After that, the battery was stored at 70° C. for 1 week. Internal resistance R1 of the battery after storage at 70° C. for 1 week was measured. The internal resistance was determined by measuring the AC resistance value (ACR) in an environment of 25° C. using the two-terminal method. The AC current measurement frequency was set to 1 kHz.

Using R0 and R1 described above, the rate of increase in internal resistance (%) was determined using the following equation.

Rate of increase in internal resistance=(R1−R0)R0×100

In Table 1, the rate of increase in internal resistance is expressed as a relative value with the rate of increase in internal resistance of the battery B2 of Comparative Example 2 being set to 100. The smaller the rate of increase in internal resistance, the more the increase in internal resistance after storage is suppressed.

For each of the batteries A1 to A3 and A5 to A10, and the batteries B2 to B6, the rate of decrease in capacity after high temperature storage was measured in the manner described below.

[Evaluation 2: Rate of Decrease in Capacity after High Temperature Storage]

Each battery was discharged immediately after assembly in an amount corresponding to 2.5% of the design capacity (C0), and stored at 60° C. for 3 days. Then, the battery after storage was discharged in an environment of 25° C. at a current of 4.5 mA per unit mass (g) of manganese dioxide until the battery voltage reached 2 V. Discharge capacity C1 (mA h/g) at this time was determined.

Using C0 and C1 described above, the rate of decrease in capacity (%) was determined using the following equation.

Rate of decrease in capacity=(C0−C1)/C0×100

In Table 2, the rate of decrease in capacity is expressed as a relative value with the rate of decease in capacity of the battery B3 of Comparative Example 3 being set to 100. The smaller the rate of decrease in capacity, the more the decrease in capacity after storage is suppressed.

The evaluation results are shown in Tables 1 and 2.

TABLE 1

| | | | | | | Rate of increase in |
|---|---|---|---|---|---|---|
| | | | | | | internal resistance |
| | First component | | Second component | | Mass ratio | after storage at 70° |
| Battery | | Concentration | | Concentration | (First component/ | C. for 1 week |
| No. | Type | (mass %) | Type | (mass %) | second component) | (relative value) |
| A1 | Phthalimide | 0.5 | LiDFOP | 1 | 0.5 | 39 |
| A2 | Phthalimide | 0.5 | LiTFOP | 1 | 0.5 | 21 |
| A3 | Phthalimide | 0.5 | LiTOP | 1 | 0.5 | 45 |
| A4 | Indole | 0.5 | LiDFOP | 1 | 0.5 | 32 |
| B1 | — | — | LiDFOP | 1 | — | 63 |
| B2 | Phthalimide | 0.5 | — | — | — | 100 |
| B3 | — | — | — | — | — | 116 |

TABLE 2

| | | | | | | Rate of decrease in |
|---|---|---|---|---|---|---|
| | First component | | Second component | | Mass ratio | capacity after storage |
| Battery | | Concentration | | Concentration | (First component/ | at 60° C. for 3 days |
| No. | Type | (mass %) | Type | (mass %) | second component) | (relative value) |
| A1 | Phthalimide | 0.5 | LiDFOP | 1 | 0.5 | 65 |
| A5 | Phthalimide | 0.5 | LiDFOP | 3 | 0.17 | 28 |
| A6 | Phthalimide | 0.5 | LiDFOP | 5 | 0.1 | 42 |
| A7 | Phthalimide | 0.3 | LiDFOP | 3 | 0.1 | 8 |
| A8 | Phthalimide | 1 | LiDFOP | 3 | 0.33 | 54 |
| A9 | Phthalimide | 0.5 | LiDFOP | 0.1 | 5 | 81 |
| A10 | Phthalimide | 0.1 | LiDFOP | 5 | 0.02 | 85 |
| A2 | Phthalimide | 0.5 | LiTFOP | 1 | 0.5 | 63 |
| A3 | Phthalimide | 0.5 | LiTOP | 1 | 0.5 | 66 |
| B4 | Phthalimide | 0.5 | LiDFOP | 0.01 | 50 | 90 |
| B5 | Phthalimide | 0.5 | LiDFOP | 7 | 0.07 | 118 |
| B6 | Phthalimide | 1.5 | LiDFOP | 1 | 1.5 | 134 |
| B2 | Phthalimide | 0.5 | — | — | — | 120 |
| B3 | — | — | — | — | — | 100 |

In the batteries A1 to A3 that contained the non-aqueous electrolyte containing the first component and the second component, the rate of increase in internal resistance after storage was significantly reduced, and the rate of decrease in capacity after storage was also significantly reduced as congaed with those of the batteries B1 to B3. The above-described advantageous effects of Examples can be obtained when the non-aqueous electrolyte satisfies at least one of the conditions (a) and (b) described above (based on comparison of Examples 1 to 3 and 5 to 10 to Comparative Examples 2 to 6).

In the battery B2 that contained the non-aqueous electrolyte containing the first component and no second component, the rate of increase in internal resistance after storage was reduced, but was insufficient, and the rate of decrease in capacity after storage increased as compared with the battery B3 that contained the non-aqueous electrolyte containing neither the first component nor the second component. Likewise, in the battery B1 that contained the non-aqueous electrolyte containing the second component and no first component as well, the suppression in internal resistance after storage was insufficient as compared with the batteries A1 to 4.

### INDUSTRIAL APPLICABILITY

With the lithium primary battery of the present disclosure, it is possible to significantly suppress an increase in internal resistance during high temperature storage. Accordingly, the lithium primary battery is preferably used as, for example, the main power supply or memory backup power supply of various types of meter. However, the applications of the lithium primary battery are not limited thereto.

### REFERENCE SIGNS LIST

1 positive electrode
1a positive electrode current collector
2 negative electrode
3 separator
4 positive electrode lead
5 negative electrode lead
6 upper insulating plate
7 lower insulating plate
8 sealing plate
9 battery case
10 lithium primary battery

1. A lithium primary battery comprising a positive electrode, a negative electrode, and a non-aqueous electrolyte,
wherein the positive electrode contains a positive electrode material mixture that contains LiₓMnO₂ (0≤x≤0.05),
the negative electrode contains at least one of metal lithium and a lithium alloy,
the non-aqueous electrolyte contains at least one of a cyclic imide component and a pyrrole component as a first component and an oxalate phosphate complex component as a second component,
the concentration of the first component in the non-aqueous electrolyte is 1 mass % or less,
the concentration of the second component in the non-aqueous electrolyte is 6 mass % or less, and
the mass ratio of the first component relative to the second component in the non-aqueous electrolyte is 0.02 or more and 10 or less.

2. A lithium primary battery comprising a positive electrode, a negative electrode, and a non-aqueous electrolyte,
wherein the positive electrode contains a positive electrode material mixture that contains LiₓMnO₂ (0≤x≤0.05),
the negative electrode contains at least one of metal lithium and a lithium alloy,
the non-aqueous electrolyte contains at least one of a cyclic imide component and a pyrrole component as a first component and an oxalate phosphate complex component as a second component,
the concentration of the first component in the non-aqueous electrolyte is 0.1 mass % or more and 1 mass % or less, and
the concentration of the second component in the non-aqueous electrolyte is 0.1 mass % or more and 6 mass % or less.

3. The lithium primary battery according to claim 2,
wherein the mass ratio of the first component relative to the second component in the non-aqueous electrolyte is 0.02 or more and 10 or less.

4. The lithium primary battery according to claim 1,
wherein the oxalate phosphate complex component contains at least one selected from the group consisting of a tetrafluoro(oxalate)phosphate complex component, a difluoro bis(oxalate)phosphate complex component, and a tris(oxalate)phosphate complex component.

5. The lithium primary battery according to claim 1,
wherein the cyclic imide component contains at least one selected front the group consisting of phthalimide and an N-substituted phthalimide.

6. The lithium primary battery according to claim 1,
wherein the cyclic imide component contains phthalimide.

7. The lithium primary battery according to claim 1,
wherein the pyrrole component contains indole.

8. The lithium primary battery according to claim 1,
wherein the positive electrode material mixture further contains a sulfate, and
the amount of sulfur atoms contained in the positive electrode material mixture is 0.05 parts by mass or more and 3 parts by mass or less relative to 100 parts by mass of manganese atoms contained in the positive electrode material mixture.

9. The lithium primary battery according to claim 1,
wherein LiₓMnO₂ has a median particle size of 10 μm or more and 40 μm or less.

10. The lithium primary battery according to claim 1,
wherein LiₓMnO₂ has a BET specific surface area of 10 m²/g or more and 40 m²/g or less.

11. The lithium primary battery according to claim 1,
wherein the positive electrode includes a porous current collector and the positive electrode material mixture filling the current collector,
the current collector contains at least one material selected from the group consisting of SUS 444, SUS 430, and SUS 316, and
the positive electrode has a thickness of 300 μm or more and 900 μm or less.

12. The lithium primary battery according to claim 1,
wherein the negative electrode includes a metal lithium foil or a lithium alloy foil, and has a shape that includes a lengthwise direction and a widthwise direction, and
a long piece of tape that includes a resin substrate and an adhesive layer is attached to at least one main surface of the negative electrode along the lengthwise direction.

13. A non-aqueous electrolyte for a lithium primary battery that is used in a lithium primary battery that includes a positive electrode that contains a positive electrode material mixture that contains LiₓMnO₂ (0≤x≤0.05), a negative electrode that contains at least one of metal lithium and a lithium alloy, and a non-aqueous electrolyte,
wherein the non-aqueous electrolyte contains at least one of a cyclic imide component and a pyrrole component as a first component and an oxalate phosphate complex component as a second component,
the concentration of the first component in the non-aqueous electrolyte is 0.1 mass % or more and 1 mass % or less, and
the concentration of the second component in the non-aqueous electrolyte is 0.1 mass % or more and 6 mass % or less.
